(19) United States
(12) Patent Application Publication
(10) Pub. No.: US 2012/0073838 A1
(43) Pub. Date: Mar. 29, 2012

(54) AEROSOL FIRE SUPPRESSION APPARATUS

(75) Inventors: Hongbao Guo, Xi'an (CN); Weipeng Zhang, Xi'an (CN); Zanfeng Zhang, Xi'an (CN); Tendfei Zhai, Xi'an (CN)

(73) Assignee: Shaanzi J & R Fire Fighting Ltd, Xian (CN)

(21) Appl. No.: 13/375,208

(22) PCT Filed: Jun. 6, 2010
(86) PCT No.: PCT/CN2010/073590

§ 371 Date: Nov. 29, 2011

(30) Foreign Application Priority Data
Jun. 8, 2009 (CN) 200910022875.0

(51) Int. Cl. A62C 31/00

(52) U.S. Cl. 169/11

(57) ABSTRACT

The present invention relates to an aerosol fire suppression apparatus, comprising enclosure, internal bladder, aerosol generating agent and initiator, and cooling layer in a cellular structure or cooling layer formed by a cellular structure coupled with coolant in a spherical or irregular shape between a chemical agent and jet orifices. The cellular structure employed in the apparatus has a large heat exchange area, which can absorb a great deal of heat in a short time, and therefore delivers good cooling effect; the cellular structure is regular in shape, easy to assemble, and the assembled aerosol fire suppression apparatus is compact in size, space-saving, and easy to install; moreover, the cellular structure can support a catalyst material to remove toxic gases produced from the aerosol, such as nitrogen oxide and carbon monoxide, etc.

### FIELD OF THE INVENTION

The present invention belongs to the technical field of fire suppression apparatuses, and relates to a cooling-type fire suppression apparatus, especially to an aerosol fire suppression apparatus.

### BACKGROUND OF THE INVENTION

Aerosol fire suppression apparatuses are novel fire suppression products that were developed in recent years, and have advantages such as high fire suppression efficacy, free of greenhouse effect and free of damage to the ozone layer, etc. In the design of an aerosol fire suppression apparatus, the cooling approach is a crucial part of the design.

Existing cooling structures are usually in spherical or other irregular shapes, for example, the aerosol fire suppression apparatus disclosed in Chinese Patent Application No. ZL02278270.2, wherein pellets made of ceramics and clay materials are used as a filtering and purification material. Almost all other coolant techniques disclosed in literatures and patent documents also employ spherical or other irregular shapes. These coolants have common drawbacks such as small specific surface area and high density, etc.; as a result, the apparatus is very bulky and difficult to handle and install. In addition, it is difficult to assemble such coolants to homogeneous state; therefore, the cooling effect is unsatisfactory. Moreover, the density of coolant may become inhomogeneous after transportation, resulting in severely adverse influence on the cooling effect.

### SUMMARY OF THE INVENTION

To overcome the above-mentioned drawbacks in the prior art, the present invention provides an aerosol fire suppression apparatus in cellular structure, which is compact in size, easy to install, and delivers good cooling effect. The technical solution of the aerosol fire suppression apparatus is described as follows:

An aerosol fire suppression apparatus, comprising enclosure, internal bladder, aerosol generating agent and initiator, and cooling layer in a cellular structure or cooling layer formed by a cellular structure coupled with coolant in a spherical or irregular shape between a chemical agent and jet orifices.

The enclosure described in the present invention is a cylinder with a thermal insulating layer or a box with an aerosol generator in it; the internal bladder is a cartridge filled with aerosol generating agent.

Furthermore, the cellular structure is made of a metal material or non-metal material.

Furthermore, the metal material is ferrum, aluminum, copper, titanium, ferro alloy, aluminum alloy, copper alloy or titanium alloy.

Furthermore, the non-metal material is made of a bonding agent and one or more the following substances: metallic oxide, hydroxide, carbonate, sulfate, phosphate, chloride, carbide, and nitride; or non-metallic oxide, carbide and nitride; or ammonium salt; or amino compound.

Furthermore, the non-metal material is a ceramic material, such as corundum, mullite, cordierite, aluminum titanate, spodumene, zirconite, carborundum or silicon nitride.

Furthermore, the cellular structure is a porous structure in a regular shape or irregular shape.

Furthermore, the cells in the cellular structure are in a polygonal, circular, elliptical or irregular shape, preferably square shape.

Furthermore, the cellular structure in the aerosol fire suppression apparatus comprises one layer, two layers or more layers.

Furthermore, in a cellular structure that comprises two or more layers, the size of cells in the outer layer is smaller than or equal to the size of cells in the inner layer.

Furthermore, the size of cells in the cellular structure is smaller than or equal to 10 mm.

Furthermore, the size of cells in the cellular structure is smaller than or equal to 3.5 mm.

Furthermore, the porosity of the cellular structure is higher than or equal to 10%, and lower than or equal to 95%.

Furthermore, the porosity of the cellular structure is higher than or equal to 20%, and lower than or equal to 80%.

Furthermore, the cellular structure is supported a catalyst material.

Furthermore, the catalyst material supported on the cellular structure is a transition metal oxide material, including ferric oxide, cupric oxide, nickel sesquioxide, manganese peroxide, or a composite thereof; or a precious metal material, including platinum, rhodium, or palladium; or a rare earth material, including oxide of a rare earth element, such as lanthanum oxide and cerous oxide, sulfate of a rare earth element, such as samarium sulfate and praseodymium sulphate, nitrate of a rare earth element, such as lanthanum nitrate and praseodymium nitrate, phosphate of a rare earth element, such as lanthanum phosphate and cerous phosphate, chloride of a rare earth element, such as cerous chloride and samaric chloride, organic acid salt of a rare earth element, such as lanthanum acetate and samarium acetate; or any composite of the above-mentioned rare earth materials.

Compared to that in the prior art, the aerosol fire suppression apparatuses in the present invention has the following advantages:

1. The cellular structure in the apparatus has a large heat exchange area, which can absorb a great deal of heat in a short time, and therefore delivers good cooling effect. 2. The cellular structure is regular in shape and easy to assemble. The assembled aerosol fire suppression apparatus is compact in size and space-saving, and easy to install. 3. The cellular structure exhibits high reproducibility of test result and is suitable for mass production. 4. The cellular structure can be supported the catalyst easily, to remove toxic gases produced from the aerosol, such as nitrogen oxide and carbon monoxide, etc.

### BRIEF DESCRIPTION OF THE DRAWINGS

FIG. 1 is a schematic structural diagram of the aerosol fire suppression apparatus in the present invention;

FIG. 2 is a schematic structural diagram of another aerosol fire suppression apparatus in the present invention;

FIG. 3 is a schematic structural diagram of another aerosol fire suppression apparatus in the present invention.

In the figures, the components are: 1—jet orifice, 2—interface of electric initiator, 3—outer cylinder assembly, 4—box, 5—chemical coolant, 6—small-cell cellular ceramic structure, 7—big-cell cellular ceramic structure, 8—aerosol generating agent, 9—ignition system, 10—jet orifice, 11—box, 12—interface of electric initiator, 13—aerosol generator, 14—cellular metal structure, 15—chemical coolant, 16—ignition system, 17—aerosol generating agent, 18—jet orifice, 19—box, 20—interface of electric initiator, 21—aerosol generator, 22—cellular carbonate structure, 23—ignition system, 24—aerosol generating agent.

### DETAILED DESCRIPTION OF THE EMBODIMENTS

The aerosol fire suppression apparatus in the present invention will be further detailed with reference to the drawings.

FIG. 1 is a schematic structural diagram of the aerosol fire suppression apparatus in the present invention. As shown in FIG. 1, the apparatus comprises jet orifices 1, outer cylinder assembly 3, box 4, chemical coolant 5, aerosol generating agent 8, ignition system 9 and initiator, wherein the outer cylinder assembly 3 forms the enclosure of the apparatus, and the cartridge (box 4) that is filled with the aerosol generating agent forms the internal bladder of the apparatus.

In this example, the initiator of the apparatus is an electric initiator, with an electric initiation interface 2. The aerosol generating agent 8 is installed in the cartridge in the outer cylinder assembly 3. After the aerosol generating agent 8 is ignited by the ignition system 9 and the aerosol is produced, which is cooled chemically by the chemical coolant 5 arranged at one end.

To get better cooling effect, physical cooling is also required. So the apparatus further has a cooling layer in cellular structure. In this example, the cooling layer comprises two layers in cellular ceramic structure, including a big-cell cellular ceramic structure 6 and a small-cell cellular ceramic structure 7, which are arranged side by side to form a physical cooling layer. In addition, the cell size of the cellular structure in the outer layer is less than or equal to the cell size of the cellular structure in the inner layer; the outer layer is made of mullite, with triangular cells in 2 mm size, at 85% porosity; the inner layer is made of corundum, with circular cells in 8 mm size, at 45% porosity; the cellular structures further are supported a catalyst material (not shown), such as manganese peroxide.

The catalyst material supported the cellular structure can be transition metal oxide, precious metal, rare earth material or composite of rare earth materials.

In the apparatus designed as above, the aerosol cooled primarily by the chemical coolant 5 is cooled physically by the cellular structures 6 and 7. Since the cellular structures have a large heat exchange area respectively, which can absorb a great deal of heat in a short time, so that the aerosol flowing out of the cellular structures can meet the design requirements. In addition, the catalyst supported the cellular structures can remove toxic gases from the aerosol, such as nitrogen oxide and carbon monoxide, so as to minimize the impact of the apparatus to the environment.

In another example, the apparatus is applied in a gas environment. In the example, the cellular structure in the outer layer is made of cordierite, with square cells in 1.5 mm size, at 65% porosity; the cellular structure in the inner layer is made of corundum, with circular cells in 5 mm size, at 35% porosity. The catalyst supported the cellular structures can be cupric oxide. If the cellular structures employed in the present invention have cells in size smaller than 3.5 mm, the temperature at the jet orifices and the temperature at the walls of the aerosol apparatus will be lower than 200° C. It is proved in simulation tests that the aerosol fire suppression apparatus in the present invention can be used safely in a gas environment.

In addition, the cooling layer in cellular structure is not limited to a cooling layer formed by cellular structures, i.e., the cooling layer can be formed by a cellular structure coupled with a coolant material in a spherical or irregular shape. Usually, the cooling layer is arranged between the chemical agent and jet orifices.

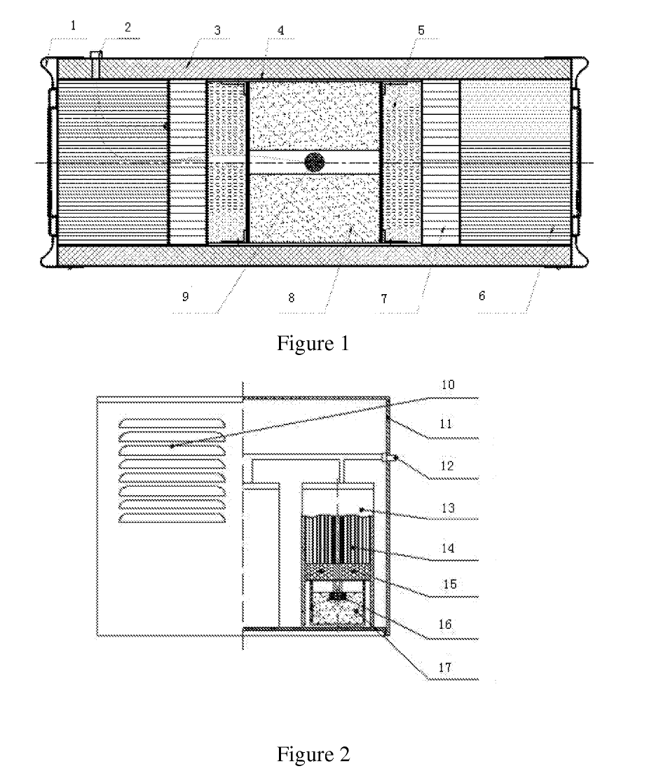

FIG. 2 is a schematic structural diagram of another aerosol fire suppression apparatus in the present invention. The apparatus comprises jet orifices 10, box 11, electric initiator interface 12, aerosol generator 13, cellular structure 14, chemical coolant 15, ignition system 16 and aerosol generating agent 17, wherein the aerosol generating agent 17 is arranged in the aerosol generator 13, the cellular structure 14 used in this example is made of steel by NC machining, with circular cells in 1.5 mm size, at 20% porosity. The catalyst supported the cellular structure is a palladium membrane.

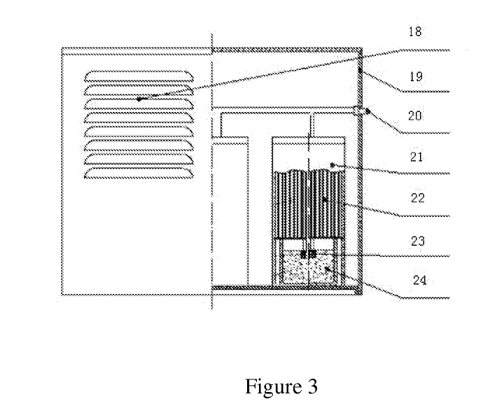

FIG. 3 is a schematic structural diagram of another aerosol fire suppression apparatus in the present invention. The apparatus comprises jet orifices 18, box 19, electric initiator interface 20, aerosol generator 21, cellular structure 22, ignition system 23 and aerosol generating agent 24, wherein the aerosol generating agent 24 is arranged in the aerosol generator 21, and the cellular structure 22 employed in the aerosol fire suppression apparatus in this example is a single layer, made of calcium carbonate by extrusion forming, with square cells in 1 mm size, at 55% porosity. Moreover, a catalyst material is supported the cellular structure, and the catalyst material is lanthanum chloride.

It is noted that there is no special restriction to the shape of the cellular structure, i.e., the cellular structure can be a porous structure in a regular shape or an irregular shape, and the cells in the cellular structure can be in a polygonal, circular, elliptical or irregular shape, preferably square shape. Moreover, the cellular structure can comprise one layer, two layers or more layers.

In addition, to get better cooling effect, the cell size of the cellular structure is preferably smaller than or equal to 10 mm, more preferably smaller than or equal to 3.5 mm

Furthermore, the porosity of the cellular structure is preferably higher than or equal to 10% and lower than or equal to 95%, more preferably higher than or equal to 20% and lower than or equal to 80%.

It is noted that above-described data and examples are exemplary. On the basis of the above instruction for the present invention, those skilled in the art can easily make modifications or variations to the embodiments without departing from the spirit of the present invention; however, all these modifications or variations shall be deemed as falling into the protective scope of the present invention. Those skilled in the art shall appreciate that the above description is only provided to elaborate and explain the object of the present invention, instead of constituting any confinement to the present invention. The protective scope of the present invention shall only be confined by the claims and their equivalence.

1. An aerosol fire suppression apparatus, comprising enclosure, internal bladder, aerosol generating agent and initiator, and cooling layer in a cellular structure or cooling layer formed by a cellular structure coupled with coolant in a spherical or irregular shape between a chemical agent and jet orifices.

2. The aerosol fire suppression apparatus according to claim 1, characterized in that the cellular structure is made of a metal material or non-metal material.

3. The aerosol fire suppression apparatus according to claim 2, characterized in that the metal material is ferrum, aluminum, copper, titanium, ferro alloy, aluminum alloy, copper alloy or titanium alloy.

4. The aerosol fire suppression apparatus according to claim 2, characterized in that the non-metal material is a material made of a bonding agent and one or more the following substances: metallic oxide, hydroxide, carbonate, sulfate, phosphate, chloride, carbide, and nitride; or non-metallic oxide, carbide, and nitride; or ammonium salt; or amino compound.

5. The aerosol fire suppression apparatus according to claim 2, characterized in that the non-metal material is a ceramic material, including corundum, mullite, cordierite, aluminum titanate, spodumene, zirconite, carborundum or silicon nitride.

6. The aerosol fire suppression apparatus according to claim 1, characterized in that the cellular structure comprises a porous structure in a regular or irregular shape.

7. The aerosol fire suppression apparatus according to claim 1, characterized in that the cells in the cellular structure are in a polygonal, circular, elliptical or irregular shape.

8. The aerosol fire suppression apparatus according to claim 1, characterized in that the cellular structure comprises one layer, two layers or more layers.

9. The aerosol fire suppression apparatus according to claim 8, characterized in that in the cellular structure that comprises two or more layers, the cell size of cellular structure in the outer layer is smaller than or equal to the cell size of cellular structure in the inner layer.

10. The aerosol fire suppression apparatus according to claim 1, characterized in that the cell size of the cellular structure is smaller than or equal to 10 mm.

11. The aerosol fire suppression apparatus according to claim 1, characterized in that the cell size of the cellular structure is smaller than or equal to 3.5 mm.

12. The aerosol fire suppression apparatus according to claim 1, characterized in that the porosity of the cellular structure is higher than or equal to 10% and lower than or equal to 95%.

13. The aerosol fire suppression apparatus according to claim 1, characterized in that the porosity of the cellular structure is higher than or equal to 20% and lower than or equal to 80%.

14. The aerosol fire suppression apparatus according to claim 1, characterized in that the cellular structure further is supported a catalyst material.

15. The aerosol fire suppression apparatus according to claim 14, characterized in that the catalyst material supported on the cellular structure is selected from the group consisting of a transition metal oxide material, a precious metal material, and a rare earth element.

16. The aerosol fire suppression apparatus according to claim 7, characterized in that the cells in the cellular structure are in a square shape.

17. The aerosol fire suppression apparatus according to claim 15, wherein the catalyst material supported on the cellular structure is a transition metal oxide material selected from the group consisting of ferric oxide, cupric oxide, nickel sesquioxide, manganese peroxide, and a composite thereof.

18. The aerosol fire suppression apparatus according to claim 15, wherein the catalyst material supported on the cellular structure is a precious metal selected from the group consisting of platinum, rhodium, and palladium.

19. The aerosol fire suppression apparatus according to claim 15, wherein the catalyst material supported on the cellular structure is a rare earth material selected from the group consisting of an oxide of a rare earth element, a sulfate of a rare earth element, a nitrate of a rare earth element, a phosphate of a rare earth element, a chloride of a rare earth element, an organic salt of rare earth element, and a composite thereof.

20. The aerosol fire suppression apparatus according to claim 19, wherein:
the oxide of the rare earth element is lanthanum oxide or cerous oxide;
the sulfate of a rare earth element is samarium sulfate or praseodymium sulphate;
the nitrate of a rare earth element is lanthanum nitrate or praseodymium nitrate;
the phosphate of a rare earth element is lanthanum phosphate or cerous phosphate;
the chloride of a rare earth element is cerous chloride or samaric chloride;
the organic acid salt of a rare earth element is lanthanum acetate or samarium acetate.
